(19) United States
(12) Patent Application Publication
(10) Pub. No.: US 2005/0124674 A1
(43) Pub. Date: Jun. 9, 2005

(54) Synergistic biocide composition

(75) Inventors: Dagmar Antoni-Zimmermann, Speyer (DE); Rudiger Baum, Waghausel (DE); Thomas Wunder, Neustadt/Weinstrasse (DE); Hans-Jurgen Schmidt, Speyer (DE)

Correspondence Address: HEDMAN & COSTIGAN P.C., 1185 AVENUE OF THE AMERICAS, NEW YORK, NY, 10036, US

(73) Assignee: Thor Chemie GmbH

(21) Appl. No.: 11/029,710

(22) Filed: Jan. 5, 2005

(30) Foreign Application Priority Data
Aug. 20, 1998 (EP) EP98115723.3

(51) Int. Cl. A01N 43/80; A01N 47/10

(52) U.S. Cl. 514/372; 514/479

(57) ABSTRACT

A biocide composition is disclosed as an additive to substances susceptible to infestation by harmful organisms, containing 2-methylisothiazolin-3-one as a biocidal agent. The composition is characterized in that it contains 3-iodo-2-propynyl-N-butylcarbamate as a farther biocidal agent, with the exception of biocide compositions containing 5-chloro-2-methylisothiazolin-3-one. In comparison to its individual constituents, the composition provided by the invention presents a synergistic biocidal action.

The invention relates to a biocide composition as an additive to substances susceptible to infestation by harmful organisms. In particular, the invention relates to a biocide composition containing 2-methylisothiazolin-3-one as a biocidal agent.

Biocidal agents are used in many areas, for example, to combat harmful bacteria, fungi, or algae. It has been known for a long time to use 4-isothiazolin-3-ones (also known as 3-isothiazolones), since these include very effective biocidal compounds.

One of those compounds is 5-chloro-2-methylisothiazolin-3-one. While it has a good biocidal effect, it also has various disadvantages during practical use. For example, the compound frequently triggers allergies in people who handle it In addition, in some countries there are legal limitations for the AOX value, i.e., a specific concentration in water of organic chlorine, bromine, and iodine compounds that are absorbable by activated charcoal may not be exceeded. Tit then prevents the use of 5-chloro-2-methylisothiazolin-3-one to the desired extent. Moreover, the stability of that compound is insufficient under certain conditions, e.g., at high pH values or in the presence of nucleophiles or reducing agents.

Another known isothiazolin-3-one with a biocidal effect is 2-methylisothiazolin-3-one. While the compound does avoid various disadvantages of 5-chloro-2-methylisothiazolin-3-one, for example, the high allergy risk, it also has a much lower biocidal effect, Simply replacing 5-chloro-2-methylisothiazolin-3-one with 2-methylisothiazolin-3-one is therefore not possible.

It is also known to use a combination of various isothiazolin-3-ones. For example, a synergistic biocide composition is described in EP 0676140 A1 that contains 2-methylisothiazolin-3-one (2-methyl-3-isothiazolone) and 2-n-octylisothiazolin-3-one (2-n-octyl-3-isothiazolone).

In JP 01224306 (Chemical Abstracts, volume 112, no. 11, Mar. 12, 1990, abstract no. 93924), a biocide composition is described that is made of 2-methylisothiazolin-3-one, 1,2-benzisothiazolin-3-one, and 5-chloro-2-methylisothiazolin-3-one.

From U.S. Pat. No. 5,328,926, synergistic biocide compositions are known that are combinations of 1,2-benzisothiazolin-3-one and an iodopropargyl compound (iodopropynyl compound). As such a compound, 3-iodopropargyl-N-butylcarbamate is mentioned.

The object of the invention is to provide a biocide composition that is improved in that its components synergistically cooperate and therefore can be used with simultaneous deployment in lower concentrations compared to the necessary concentrations in the case of individual components. In that way, humans and the environment are to be less polluted and the costs of combating harmful microorganisms are to be reduced.

The object is attained according to the invention by a biocide composition containing 2-methylisothiazolin-3-one as a biocidal agent, which is characterized in that it contains, as a further biocidal agent, 3-iodo-2-propynyl-N-butylcarbamate, with the exception of biocide compositions containing 5-chloro-2-methylisothiazolin-3-one.

The biocide composition according to the invention has the advantage that it can replace active ingredients that have previously been used in practice but that have disadvantages with regard to health and the environment, such as 5-chloro-2-methylisothiazolin-3-one.

Moreover, the biocide compositions according to the invention can be produced, if necessary, using only water as a liquid medium. In that regard, the addition of emulsifiers, organic solvents, and/or stabilizers is not necessary.

The biocide composition according to the invention contains 2-methylisothiazolin-3-one and the 3-iodo-2-propynyl-N-butylcarbamate normally in the weight ratio of (100-1):(1-50), preferably in the weight ratio of (15-1):(1-8), in particular in the weight ratio of (4-1):(1-4).

In the biocide composition, 2-methylisothiazolin-3-one and 3-iodo-2-propynyl-N-butylcarbamate are present in a total concentration of preferably 0.5 to 50% by weight, in particular from 1 to 20% by weight, particularly preferably from 2.5 to 10% by weight, in each case based on the total biocide composition.

It is useful to use the biocides of the composition according to the invention in combination with a polar or nonpolar liquid medium. In that regard, that medium can be, for example, already present in the biocide composition and/or in the material to be preserved.

Preferable polar liquid media are water, an aliphatic alcohol having 1 to 4 carbon atoms, e.g., ethanol and isopropanol, a glycol, e.g., ethylene glycol, diethylene glycol, 1,2-propylene glycol, dipropylene glycol, and tripropylene glycol, a glycol ether, e.g., ethylene glycol monobutyl ether and diethylene glycol monobutyl ether, a glycol ester, e.g., butyl diglycol acetate, 2,2,4-trimethylpentanediolmonoisobutyrate, a polyethylene glycol, a polypropylene glycol, N,N-dimethylformamide, or a mixture of such substances. The polar liquid medium is in particular water, with the corresponding biocide composition preferably being neutral in its pH value, e.g., adjusted to a pH value of 6 to 8.

As a nonpolar liquid medium, aromatics, preferably xylene and toluene, are used.

The biocide composition according to the invention can also simultaneously be combined with a polar and a nonpolar liquid medium.

The biocide composition according to the invention can also contain one or more additional biocidal ingredients, which are selected as a function of the area of application. Special examples of such additional biocidal agents are listed below,
Benzyl alcohol
2,4-dichlorobenzyl alcohol
2-phenoxyethanol
2-phenoxyethanol hemiformal
Phenylethyl alcohol
5-bromo-5-nitro-1,3-dioxane
Formaldehyde and formaldehyde releasing substances
Dimethylol dimethylhydantoin
Glyoxal
Glutardialdehyde
Sorbic acid
Bbenzoic acid
Salicylic acid
P-hydroxybenzoic acid ester
Chloroacetamide
N-methylolchloroacetamide
Phenols such as p-chloro-m-cresol and o-phenylphenol
N-methylolurea
N,N′-dimethylolurea
Benzyl formal
4,4-dimethyl-1,3-oxazolidine
1,3,5-hexahydrotriazine
Quaternary ammonium compounds, such as
   N-alkyl-N,N-dimethylbenzyl ammonium chloride and
   di-n-decyldimethyl ammonium chloride
Cetyl pyridinium chloride
Diguanidin
Polybiguanide
Chlorhexidine
1,2-dibromo-2,4-dicyanobutane
3,5-dichloro-4-hydroxybenzaldehyde
Ethylene glycol hemiformal
Tetra-(hydroxymethyl)-phosphonium salts
Dichlorophene
2,2-dibromo-3-nitrilopropionic acid amide
Methyl-N-benzimidazole-2-ylcarbamate
2-n-octylisothiazolin-3-one
4,5-dichloro-2-n-octylisothiazolin-3-one
4,5-trimethylene-2-methylisothiazolin-3-one
2,2′-dithio-dibenzoic acid-di-N-methylamide
Benzisothiazolinone derivatives
2-thiocyanomethylthiobenzothiazole
C-formals, such as
   2-hydroxymethyl-2-nitro-1,3-propandiol
   2-bromo-2-nitropropane-1,3-diol
   Reaction products of allantoin

Examples of the formaldehyde retardant substances are
N-formals such as
   N,N′-dimethylolurea
   N-methylolurea
   Dimethylol dimethylhydantoin
   N-methylol chloroacetamide
   Reaction products of allantoin
Glycol formals, such as
   Ethylene glycol formal
   Diethylene glycol monobutyl ether formal
   Benzyl formal

The biocide composition according to the invention can contain other common ingredients that are known to those skilled in the art in the area of biocides. They are, for example, thickeners, anti-foaming agents, substance for adjusting pH value, aromas, dispersion aids, and coloring agents.

2-Methylisothiazolin-3-one and 3-iodo-2-propynyl-N-butylcarbamate are known substances. 2-Methylisothiazolin-3-one can be prepared, for example, according to U.S. Pat. No. 5,466,818. The reaction product thus obtained can be purified using, for example, column chromatography. The reaction product obtained when that is done can be purified using, for example, column chromatography.

3-Iodo-2-propynyl-N-butylcarbamate is commercially available, for instance, from Troy Chemical Company under the trade names Polyphase®, Polyphase® AF-1, and Polyphase® NP-1 or from Olin Corporation under the trade name Omacide® IPBC 100.

The biocide composition according to the invention is a system in which the combination of 2-methylisothiazolin-3-one and 3-iodo-2-propynyl-N-butylcarbamate synergistically develops a biocidal effect that is greater than that possessed by each of those compounds alone.

The biocide composition according to the invention can be used in very different areas. It is suitable, for example, for use in paints, plasters, lignin sulfonates, whitewashes, adhesives, photochemicals, products containing casein, products containing starch, asphalt emulsions, surfactant solutions, fuels, cleaning agents, cosmetic products, water systems, polymer dispersions, and cold lubricants for protecting against infestation, for example, by bacteria, filamentous fungi, yeasts, and algae.

In practical application, the biocide composition can either be applied as a ready-made mixture or by separately adding the biocides and the other components of the composition to the substance to be preserved.

The Examples explain the invention.

### EXAMPLE 1

This Example demonstrates the synergy of combinations of 2-methylisothiazolin-3-one and 3-iodo-2-propynyl-N-butylcarbamate in the biocide composition according to the invention.

For that purpose, aqueous mixtures with different concentrations of 2-methylisothiazolin-3-one (MIT) and 3-iodo-2-propynyl-N-butylcarbamate (IPBC) were produced and the effects of those mixtures on Saccharomyces cerevisiae were tested.

In addition to the biocide components and water, the aqueous mixtures also contained a nutrient medium, specifically a Sabouraud maltose broth (trade product “Merck No. 10393”). The cell density of Saccharomyces cerevisiae was 10⁶ cells/ml. The incubation time was 72 hours at 25° C. Each sample was incubated at 120 r.p.m. on an incubation shaker.

Table I below provides the concentrations of MIT and IPBC that were used. It also shows whether growth of the microorganism occurred (“+” symbol) or not (“−” symbol).

Table I therefore also shows the minima inhibitory concentration (MIC). Accordingly, with the use of MIT alone the result was an MIC value of 150 ppm and with the use of IPBC alone the result was an MIC value of 10 ppm. In contrast, the MIC values of mixtures of MIT and IPBC are clearly lower; in other words, MIT and IPBC have a synergistic effect in combination.

TABLE I
MIC values for Saccharomyces cerevisiae
at an incubation time of 72 hours

| MIT | | | | | | | | | | | |
|---|---|---|---|---|---|---|---|---|---|---|---|
| Concentration | IPBC concentration (ppm) | | | | | | | | | | |
| (ppm) | 15 | 12.5 | 10 | 7.5 | 5 | 4 | 3 | 2 | 1 | 0.5 | 0 |
| 300 | − | − | − | − | − | − | − | − | − | − | − |
| 250 | − | − | − | − | − | − | − | − | − | − | − |
| 200 | − | − | − | − | − | − | − | − | − | − | − |
| 150 | − | − | − | − | − | − | − | − | − | − | − |
| 100 | − | − | − | − | − | − | − | − | + | + | + |
| 75 | − | − | − | − | − | − | + | + | + | + | + |
| 50 | − | − | − | − | − | + | + | + | + | + | + |
| 25 | − | − | − | − | − | + | + | + | + | + | + |
| 15 | − | − | − | − | + | + | + | + | + | + | + |
| 10 | − | − | − | − | + | + | + | + | + | + | + |
| 5 | − | − | − | − | + | + | + | + | + | + | + |
| 0 | − | − | − | + | + | + | + | + | + | + | + |

The synergy that occurs is shown in numerical terms based on the calculation of the synergy index shown in Table II. The calculation of the synergy index is performed according to the method by F. C. Kull et al., Applied Microbiology, vol. 9 (1961), p. 538. The synergy index is calculated here using the following formula:
Synergy index SI=Qₐ/Q_{A}+Q_{b}/Q_{B}.

When this formula is used for the biocide system tested here, the variables in the formula have the following meaning:
Q_{B}=Concentration of MIT in biocide mixture of MIT and IPBC
Q_{A}=Concentration of MIT as the only biocide
Q_{b}=Concentration of IPBC in biocide mixture of MIT and IPBC
Q_{B}=Concentration of IPBC as the only biocide

When the synergy index shows a value greater than 1, that means that an antagonism is present When the synergy index has a value of 1, that means there was an addition of the effect of both biocides. When the synergy index has a value of less than 1, that means that a synergy of the two biocides exists.

TABLE II
Calculation of the synergy index for Saccharomyces
cerevisiae at an incubation time of 72 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 10 | 10 | 0.0 | 100.0 | 0.00 | 1.00 | 1.00 |
| 5 | 7.5 | 12.5 | 40.0 | 60.0 | 0.03 | 0.75 | 0.78 |
| 10 | 7.5 | 17.5 | 57.1 | 42.9 | 0.07 | 0.75 | 0.82 |
| 25 | 5 | 30 | 83.3 | 16.7 | 0.17 | 0.50 | 0.67 |
| 50 | 5 | 55 | 90.9 | 9.1 | 0.33 | 0.50 | 0.83 |
| 75 | 4 | 79 | 94.9 | 5.1 | 0.50 | 0.40 | 0.90 |
| 100 | 2 | 102 | 98.0 | 2.0 | 0.67 | 0.20 | 0.87 |
| 150 | 0 | 150 | 100.0 | 0.0 | 1.00 | 0.00 | 1.00 |

Table II shows that the optimum synergy, e.g., the lowest synergy index (0.67) of an MIT/IPBC mixture, was at a mixture of 83.3% by weight MIT and 16.7% by weight IPBC.

### EXAMPLE 2

Example 1 was repeated with the change that the incubation time was 96 hours instead of 72 hours.

Table III below shows the MIC values of the tested biocide compositions. The MIC value with the use of MIT alone was 150 ppm and with the use of IPBC alone 10 ppm.

TABLE III
MIC values for Saccharomyces cerevisiae
at an incubation time of 96 hours

| MIT | | | | | | | | | | | |
|---|---|---|---|---|---|---|---|---|---|---|---|
| Concentration | IPBC concentration (ppm) | | | | | | | | | | |
| (ppm) | 15 | 12.5 | 10 | 7.5 | 5 | 4 | 3 | 2 | 1 | 0.5 | 0 |
| 300 | − | − | − | − | − | − | − | − | − | − | − |
| 250 | − | − | − | − | − | − | − | − | − | − | − |
| 200 | − | − | − | − | − | − | − | − | − | − | − |
| 150 | − | − | − | − | − | − | − | − | − | − | − |
| 100 | − | − | − | − | − | − | − | − | + | + | + |
| 75 | − | − | − | − | − | − | + | + | + | + | + |
| 50 | − | − | − | − | − | + | + | + | + | + | + |
| 25 | − | − | − | − | − | + | + | + | + | + | + |
| 15 | − | − | − | − | + | + | + | + | + | + | + |
| 10 | − | − | − | − | + | + | + | + | + | + | + |
| 5 | − | − | − | − | + | + | + | + | + | + | + |
| 0 | − | − | − | + | + | + | + | + | + | + | + |

With simultaneous use of MIT and IPBC, a synergy occurred. The calculation of the synergy index is shown in Table IV. According to it, the lowest synergy index (0.67) for Saccharomyces cerevisiae was at a mixture of 83.3% by weight MIT and 16.7% by weight IPBC.

TABLE IV
Calculation of the synergy index for Saccharomyces
cerevisiae at an incubation time of 96 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 10 | 10 | 0.0 | 100.0 | 0.00 | 1.00 | 1.00 |
| 5 | 7.5 | 12.5 | 40.0 | 60.0 | 0.03 | 0.75 | 0.78 |
| 10 | 7.5 | 17.5 | 57.1 | 42.9 | 0.07 | 0.75 | 0.82 |
| 25 | 5 | 30 | 83.3 | 16.7 | 0.17 | 0.50 | 0.67 |
| 50 | 5 | 55 | 90.9 | 9.1 | 0.33 | 0.50 | 0.83 |
| 75 | 4 | 79 | 94.9 | 5.1 | 0.50 | 0.40 | 0.90 |
| 100 | 2 | 102 | 98.0 | 2.0 | 0.67 | 0.20 | 0.87 |
| 150 | 0 | 150 | 100.0 | 0.0 | 1.00 | 0.00 | 1.00 |

### EXAMPLE 3

As in Example 1, the synergy of MIT and IPBC in relation to the microorganism Candida valida is demonstrated.

The test arrangements again included a Sabouraud maltose broth as culture medium. The cell density was 10⁶ cells/ml. The incubation time was 96 hours at 25° C. Every sample was incubated at 120 r.p.m. on an incubation shaker.

Table V below shows the MIC values of the tested biocide compositions. The MIC value with the use of NUT alone was 75 ppm and 2.5 ppm with the use of IPBC alone.

TABLE V
MIC values for Candida valida
at an incubation time of 96 hours

| MIT | | | | | | | | | | | |
|---|---|---|---|---|---|---|---|---|---|---|---|
| Concentra- | | | | | | | | | | | |
| tion | IPBC concentration (ppm) | | | | | | | | | | |
| (ppm) | 7.5 | 5 | 2.5 | 2 | 1.5 | 1.25 | 1 | 0.75 | 0.5 | 0.25 | 0 |
| 300 | − | − | − | − | − | − | − | − | − | − | − |
| 250 | − | − | − | − | − | − | − | − | − | − | − |
| 200 | − | − | − | − | − | − | − | − | − | − | − |
| 150 | − | − | − | − | − | − | − | − | − | − | − |
| 100 | − | − | − | − | − | − | − | − | − | − | − |
| 75 | − | − | − | − | − | − | − | − | − | − | − |
| 50 | − | − | − | − | − | − | − | + | + | + | + |
| 25 | − | − | − | − | − | − | − | + | + | + | + |
| 15 | − | − | − | − | − | + | + | + | + | + | + |
| 10 | − | − | − | − | − | + | + | + | + | + | + |
| 5 | − | − | − | + | + | + | + | + | + | + | + |
| 0 | − | − | − | + | + | + | + | + | + | + | + |

With simultaneous use of MIT and IPBC, a synergy occurred. The calculation of the synergy index is shown in Table VI. According to it, the lowest synergy index (0.73) for Candida valida was at a mixture of 87.0% by weight MIT and 13% by weight IPBC, as well as at a mixture of 96.2% by weight NUT and 3.8% by weight IPBC.

TABLE VI
Calculation of synergy for Candida valida
at an incubation time of 96 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 2.5 | 2.5 | 0.0 | 100.0 | 0.00 | 1.00 | 1.00 |
| 10 | 2 | 12 | 83.3 | 16.7 | 0.13 | 0.80 | 0.93 |
| 10 | 1.5 | 11.5 | 87.0 | 13.0 | 0.13 | 0.60 | 0.73 |
| 15 | 1.5 | 16.5 | 90.9 | 9.1 | 0.20 | 0.60 | 0.80 |
| 25 | 1.5 | 26.5 | 94.3 | 5.7 | 0.33 | 0.60 | 0.93 |
| 25 | 1.25 | 26.25 | 95.2 | 4.8 | 0.33 | 0.50 | 0.83 |
| 25 | 1 | 26 | 96.2 | 3.8 | 0.33 | 0.40 | 0.73 |
| 75 | 0 | 75 | 100.0 | 0.0 | 1.00 | 0.00 | 1.00 |

### EXAMPLE 4

As in Example 1, the synergy of the two active ingredients MIT and IPBC in relation to the microorganism Aspergillus niger is demonstrated.

The test arrangements again included a Sabouraud maltose broth as culture medium. The cell density was 10⁶ cells/ml. The incubation time was 96 hours at 25° C. Every sample was incubated at 120 r.p.m. on an incubation shaker.

Table VII below shows the MIC values of the tested biocide compositions. The MIC value with the use of NUT alone was 750 ppm and with the use of IPBC alone 5 ppm.

TABLE VII
MIC values for Aspergillus niger
at an incubation time of 96 hours

| MIT | | | | | | | | | | | |
|---|---|---|---|---|---|---|---|---|---|---|---|
| Concentra- | | | | | | | | | | | |
| tion | IPBC concentration (ppm) | | | | | | | | | | |
| (ppm) | 5 | 2.5 | 2 | 1.5 | 1.25 | 1 | 0.75 | 0.5 | 0.25 | 0.1 | 0 |
| 750 | − | − | − | − | − | − | − | − | − | − | − |
| 500 | − | − | − | − | − | − | + | + | + | + | + |
| 250 | − | − | − | + | + | + | + | + | + | + | + |
| 100 | − | − | + | + | + | + | + | + | + | + | + |
| 50 | − | + | + | + | + | + | + | + | + | + | + |
| 40 | − | + | + | + | + | + | + | + | + | + | + |
| 30 | − | + | + | + | + | + | + | + | + | + | + |
| 20 | − | + | + | + | + | + | + | + | + | + | + |
| 15 | − | + | + | + | + | + | + | + | + | + | + |
| 10 | − | + | + | + | + | + | + | + | + | + | + |
| 7.5 | − | + | + | + | + | + | + | + | + | + | + |
| 5 | − | + | + | + | + | + | + | + | + | + | + |
| 0 | − | + | + | + | + | + | + | + | + | + | + |

With simultaneous use of MIT and IPBC, a synergy occurred. The calculation of the synergy index is shown in Table VIII According to it, the lowest synergy index (0.63) for Aspergillus niger was at a mixture of 97.6% by weight MIT and 2.4% by weight IPBC.

TABLE VIII
Calculation of the synergy index for Aspergillus niger
at an incubation time of 96 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 5 | 5 | 0.0 | 100.0 | 0.00 | 1.00 | 1.00 |
| 100 | 2.5 | 102.5 | 97.6 | 2.4 | 0.13 | 0.50 | 0.63 |
| 250 | 2.5 | 252.5 | 99.0 | 1.0 | 0.33 | 0.50 | 0.83 |
| 250 | 2 | 252 | 99.2 | 0.8 | 0.33 | 0.40 | 0.73 |
| 500 | 1.5 | 501.5 | 99.7 | 0.3 | 0.67 | 0.30 | 0.97 |
| 500 | 1.25 | 501.25 | 99.8 | 0.2 | 0.67 | 0.25 | 0.92 |
| 500 | 1 | 501 | 99.8 | 0.2 | 0.67 | 0.20 | 0.87 |
| 750 | 0 | 750 | 100.0 | 0.0 | 1.00 | 0.00 | 1.00 |

### EXAMPLE 5

As in Example 1, the synergy of the two active ingredients MIT and IPBC in relation to the microorganism Penicillium funiculosum is demonstrated.

The test arrangement again included a Sabouraud maltose broth as culture medium. The cell density was 10⁶ germs/ml. The incubation time was 72 hours at 25° C. Every sample was incubated at 120 r.p.m. on an incubation shaker.

Table IX below shows the MIC values of the tested biocide compositions. The NIC value with the use of MIT alone was 200 ppm and with the use of IPBC alone 1.5 ppm.

TABLE IX
MIC values for Penicillium funiculosum
at an incubation time of 72 hours

| MIT | | | | | | | | | | | |
|---|---|---|---|---|---|---|---|---|---|---|---|
| Concentra- | | | | | | | | | | | |
| tion | IPBC concentration (ppm) | | | | | | | | | | |
| (ppm) | 5 | 2.5 | 2 | 1.5 | 1.25 | 1 | 0.75 | 0.5 | 0.25 | 0.1 | 0 |
| 200 | − | − | − | − | − | − | − | − | − | − | − |
| 150 | − | − | − | − | − | − | − | − | − | + | + |
| 100 | − | − | − | − | − | − | − | − | + | + | + |
| 75 | − | − | − | − | − | − | − | − | + | + | + |
| 50 | − | − | − | − | − | − | + | + | + | + | + |
| 40 | − | − | − | − | − | − | + | + | + | + | + |
| 30 | − | − | − | − | − | − | + | + | + | + | + |
| 20 | − | − | − | − | − | + | + | + | + | + | + |
| 15 | − | − | − | − | − | + | + | + | + | + | + |
| 10 | − | − | − | − | − | + | + | + | + | + | + |
| 5 | − | − | − | − | + | + | + | + | + | + | + |
| 0 | − | − | − | − | + | + | + | + | + | + | + |

With simultaneous use of MIT and IPBC, a synergy occurred. The calculation of the synergy index is contained in Table X. According to it, the lowest synergy index (0.71) for Penicillium funiculosum was at a mixture of 99.3% by weight MIT and 0.7% by weight IPBC.

TABLE X
Calculation of the synergy index for Penicillium
funiculosum at an incubation time of 72 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 1.5 | 1.5 | 0.0 | 100.0 | 0.00 | 1.00 | 1.00 |
| 10 | 1.25 | 11.25 | 88.9 | 11.1 | 0.05 | 0.83 | 0.88 |
| 15 | 1.25 | 16.25 | 92.3 | 7.7 | 0.08 | 0.83 | 0.91 |
| 20 | 1.25 | 21.25 | 94.1 | 5.9 | 0.10 | 0.83 | 0.93 |
| 30 | 1 | 31 | 96.8 | 3.2 | 0.15 | 0.67 | 0.82 |
| 40 | 1 | 41 | 97.6 | 2.4 | 0.20 | 0.67 | 0.87 |
| 50 | 1 | 51 | 98.0 | 2.0 | 0.25 | 0.67 | 0.92 |
| 75 | 0.75 | 75.75 | 99.0 | 1.0 | 0.38 | 0.50 | 0.88 |
| 75 | 0.5 | 75.5 | 99.3 | 0.7 | 0.38 | 0.33 | 0.71 |
| 150 | 0.25 | 150.25 | 99.8 | 0.2 | 0.75 | 0.17 | 0.92 |
| 200 | 0 | 200 | 100.0 | 0.0 | 1.00 | 0.00 | 1.00 |

### EXAMPLE 6

Example 5 was repeated with the change that the incubation time was 96 hours instead of 72 hours.

Table XI below shows the MIC values of the tested biocide compositions. The MIC value with the use of MIT alone was 200 ppm and with the use of IPBC alone 1.5 ppm.

TABLE XI
MIC values for Penicillium funiculosum
at an incubation time of 96 hours

| MIT | | | | | | | | | | | |
|---|---|---|---|---|---|---|---|---|---|---|---|
| Concentra- | | | | | | | | | | | |
| tion | IPBC concentration (ppm) | | | | | | | | | | |
| (ppm) | 5 | 2.5 | 2 | 1.5 | 1.25 | 1 | 0.75 | 0.5 | 0.25 | 0.1 | 0 |
| 200 | − | − | − | − | − | − | − | − | − | − | − |
| 150 | − | − | − | − | − | − | − | − | − | + | + |
| 100 | − | − | − | − | − | − | − | − | + | + | + |
| 75 | − | − | − | − | − | − | − | − | + | + | + |
| 50 | − | − | − | − | − | − | + | + | + | + | + |
| 40 | − | − | − | − | − | − | + | + | + | + | + |
| 30 | − | − | − | − | + | + | + | + | + | + | + |
| 20 | − | − | − | − | + | + | + | + | + | + | + |
| 15 | − | − | − | − | + | + | + | + | + | + | + |
| 10 | − | − | − | − | + | + | + | + | + | + | + |
| 5 | − | − | − | − | + | + | + | + | + | + | + |
| 0 | − | − | − | − | + | + | + | + | + | + | + |

With simultaneous use of NUT and IPBC, a synergy occurred. The calculation of the synergy index is contained in Table XII. According to it, the lowest synergy index (0.71) for Penicillium funiculosum was at a mixture of 99.3% by weight NUT and 0.7% by weight IPBC.

TABLE XII
Calculation of the synergy index for Penicillium
funiculosum at an incubation time of 96 hours

| | | Total | | | | | |
|---|---|---|---|---|---|---|---|
| MIC at | | concentration | | | | | |
| MIT | IPBC | MIT + IPBC | Concentration | | | | Synergy |
| concentration | concentration | Qₐ + Q_{b} | MIT | IPBC | | | index |
| Qₐ (ppm) | Q_{b} (ppm) | (ppm) | (% wt) | (% wt) | Qₐ/Q_{A} | Q_{b}/Q_{B} | Qₐ/Q_{A} + Q_{b}/Q_{B} |
| 0 | 1.5 | 1.5 | 0.0 | 100.0 | 0.00 | 1.00 | 1.00 |
| 40 | 1 | 41 | 97.6 | 2.4 | 0.20 | 0.67 | 0.87 |
| 50 | 1 | 51 | 98.0 | 2.0 | 0.25 | 0.67 | 0.92 |
| 75 | 0.75 | 75.75 | 99.0 | 1.0 | 0.38 | 0.50 | 0.88 |
| 75 | 0.5 | 75.5 | 99.3 | 0.7 | 0.38 | 0.33 | 0.71 |
| 150 | 0.25 | 150.25 | 99.8 | 0.2 | 0.75 | 0.17 | 0.92 |
| 200 | 0 | 200 | 100.0 | 0.0 | 1.00 | 0.00 | 1.00 |

1. (canceled)

2. (canceled)

3. (canceled)

4. (canceled)

5. (canceled)

6. (canceled)

7. (canceled)

8. (canceled)

9. Biocide composition as an additive to substances susceptible to infestation by harmful organisms, said biocide composition consisting essentially of a biocidal amount of 2-methylisothiazolin-3-one, a biocidal amount of 3-iodo-2-propynyl-N-butylcarbamate and a polar or non-polar liquid medium.

10. Biocide composition according to claim 9, characterized in that it contains 2-methylisothiazolin-3-one and 3-iodo-2-propynyl-N-butylcarbamate in a weight ratio of (100-1):(1-50).

11. Biocide composition according to claim 10, characterized in that it contains 2-methylisothiazolin-3-one and 3-iodo-2-propynyl-N-butylcarbamate in a weight ratio of (15-1):(1-8).

12. Biocide composition according to claim 9, characterized in that it contains 2-methylisothiazolin-3-one and 3-iodo-2-propynyl-N-butylcarbamate in a total concentration of 1 to 20% by weight based on the total biocide composition.

13. Biocide composition according to claim 9 characterized in that it contains a polar and/or a nonpolar liquid medium.

14. Biocide composition according to claim 9, characterized in that it contains as polar liquid medium water, an aliphatic alcohol having 1 to 4 carbon atoms, a glycol, a glycol ether, a glycol ester, a polyethylene glycol, a polypropylene glycol, N,N-dimethylformamide, 2,2,4-trimethylpentanediolisobutyrate, or a mixture of such substances.

15. Biocide composition according to claim 9, characterized in that the polar liquid medium is water and the composition has a pH value of 6 to 8.

16. A method of combatting harmful microorganisms which comprises applying an effective amount of a biocide composition according to claim 9.

17. A biocide composition according to claim 9, said biocide composition consisting essentially of 2-methylisothiazolin-3-one and 3-iodo-2-propynyl-N-butylcarbamate in a weight ratio of (100-1):(1-50) and a polar or non-polar liquid medium.

18. Biocide composition according to claim 9, said biocide composition consisting of a biocidal amount of 2-methylisothiazolin-3-one, a biocidal amount of 3-iodo-2-propynyl-N-butylcarbamate and a polar or non-polar liquid medium.

19. Biocide composition according to claim 18, characterized in that it contains 2-methylisothiazolin-3-one and 3-iodo-2-propynyl-N-butylcarbamate in a weight ratio of (100-1):(1-50).

20. Biocide composition according to claim 19, characterized in that it contains 2-methylisothiazolin-3-one and 3-iodo-2-propynyl-N-butylcarbamate in a weight ratio of (15-1):(1-8).

21. Biocide composition according to claim 9 characterized in that it contains 2-methylisothiazolin-3-one and 3-iodo-2-propynyl-N-butylcarbamate in a total concentration of 1 to 20% by weight based on the total biocide composition.

22. Biocide composition according to claim 9, characterized in that it contains a polar and/or a nonpolar liquid medium.

23. Biocide composition according to claim 9, characterized in that it contains as polar liquid medium water, an aliphatic alcohol having 1 to 4 carbon atoms, a glycol, a glycol ether, a glycol ester, a polyethylene glycol, a polypropylene glycol, N,N-dimethylformamide, 2,2,4-trimethylpentanediolmonoisobutyrate, or a mixture of such substances.

24. Biocide composition according to claim 9, characterized in that the polar liquid medium is water and the composition has a pH value of 6 to 8.

25. A method of combatting harmful microorganisms which comprises applying to said microorganisms an effective amount of a biocide composition according to claim 9.

26. A biocide composition, said biocide composition consisting of 2-methylisothiazolin-3-one and 3-iodo-2-propynyl-N-butylcarbamate in a weight ratio of (100-1):(1-50) and a polar or non-polar liquid medium.
